(19) United States
(12) Patent Application Publication
(10) Pub. No.: US 2008/0007086 A1
(43) Pub. Date: Jan. 10, 2008

(54) VEHICLE SHADING SYSTEM AND METHOD USING AN ELECTRICALLY CONTROLLED TRANSMISSION CONTROL MATERIAL

(76) Inventor: Ram Pattikonda, Richardson, TX (US)

Correspondence Address: Michael L. Diaz;Michael L. Diaz, P.C., Suite 200, 555 Republic Drive, Plano, TX, 75074, US

(21) Appl. No.: 11/608,317

(22) Filed: Dec. 8, 2006

Related U.S. Application Data
(60) Provisional application No. 60/748,874, filed on Dec. 10, 2005.

(51) Int. Cl. B60J 1/10

(52) U.S. Cl. 296/146.15

(57) ABSTRACT

A vehicle shading system for shading an interior of a vehicle. The vehicle shading system includes a plurality of windows located on the vehicle. Each window has a transmission control material which changes from transparent to opaque upon an application of an electric current to the transmission control material. The system also includes a controller for controlling the application of the electric current to the transmission control material. In addition, the system includes a power source providing the electric current to the transmission control material when commanded by the controller. Each window is changed from transparent to opaque when commanded by the controller by applying the electric current from the power source to the transmission control material, thereby shading the interior of the vehicle. The system may optionally include sensors to detect if the engine is off, a temperature sensor to determine if the interior temperature of the vehicle is above a specified temperature and a daylight sensor to detect if it is daylight. One or more of these sensors may be utilized to determine if the controller may command an activation of the shading system.

### RELATED APPLICATIONS

This utility application claims the benefit of U.S. Provisional Patent Application Ser. No. 60/748,874 by Ram Pattikonda, filed Dec. 10, 2005, and is hereby incorporated by reference.

### BACKGROUND OF THE INVENTION

1. Field of the Invention

This invention relates to vehicle devices. Specifically, and not by way of limitation, the present invention relates to a vehicle shading system using an electrically controlled transmission control material.

2. Description of the Related Art

The interior of a vehicle can become extremely hot when exposed to the sun. The high temperatures of the vehicle's interior results in several well known problems. To the driver and passengers of such a vehicle, the interior is hot and uncomfortable and touching surfaces may burn a person's skin. Because of this extreme heat, energy must be expended to cool the interior. Specifically, the vehicle's air conditioning system must be operated at full power when the driver or passengers enter the vehicle. In addition, the high temperatures have been known to cause death or severe injury to infants and pets left behind within a shutdown vehicle. Also, because of the constant exposure to the sun, the vehicle's interior often fades and deteriorates.

Currently, most of the existing devices to alleviate the high temperatures and exposure to the sun are limited to mechanical shades. The mechanical shades typically are some type of rigid foldable panel which is manually positioned on the front windshield. The operation of setting up and dismantling the mechanically shades is tedious and cumbersome. Because of this inconvenient operation, most people ignore or forget to use the mechanical shade. Additionally, these existing mechanical shades merely cover the front windshield without covering the other windows of the vehicle. Thus, the interior of the vehicle is still exposed to the sun.

Most vehicles also include tinted windows. However, because of local laws limiting the amount of tinting allowed in windows, the tint is limited in its darkness. Because of this limitation, the tinting utilized in vehicle windows, at best, still provides less than a fifty percent reduction in heat and light.

Accordingly, a system and method are needed which automatically and economically shades all the windows of a vehicle. It is an object of the present invention to provide such a method and system.

### SUMMARY OF THE INVENTION

In one aspect, the present invention is a vehicle shading system for shading an interior of a vehicle. The vehicle shading system includes a plurality of windows located on the vehicle. Each window has a transmission control material which changes the transmissivity of the window between a transparent state and an opaque state by an application of an electric current to the transmission control material. In one embodiment, the transmission control material is opaque when an electric current is applied to the transmission control material and transparent when the electric current is removed from the transmission control material. In another embodiment, the transmission control material remains a constant state of opaque or state of transparent without electric current being applied and changes from opaque to transparent or changes from transparent to opaque upon the application of the electric current. The system also includes a controller for controlling the application of the electric current to the transmission control material. In addition, the system includes a power source providing the electric current to the transmission control material when commanded by the controller. Each window is changed from transparent to opaque when commanded by the controller, thereby shading the interior of the vehicle. The system may optionally include sensors to detect if the engine is off, a temperature sensor to determine if the interior temperature of the vehicle is above a specified temperature and a daylight sensor to detect if it is daylight. One or more of these sensors may be utilized to determine if the controller may command an activation of the shading system.

In another aspect, the present invention is a method of shading an interior of a vehicle. The method begins by determining an appropriate time by a controller to apply an electric current to a plurality of windows of the vehicle. The windows each include a transmission control material layer which changes the transmissivity of the window between a transparent state and an opaque state by an application of an electric current to the transmission control material. Upon determining that it is an appropriate time to apply electric current to the windows, the electric current is applied to the windows, thereby transforming the transmissivity of the plurality of windows to shade the interior of the vehicle.

### BRIEF DESCRIPTION OF THE DRAWINGS

FIG. 1 is a simplified block diagram of a vehicle shading system in the preferred embodiment of the present invention;

FIG. 2 is a simplified illustration of the plurality of window panels of a vehicle shaded by the vehicle shading system of FIG. 1;

FIG. 3 is an illustration of a transmission control material panel utilized in the vehicle shading system in an off position;

FIG. 4 is an illustration of the transmission control material panel in an on position; and

FIG. 5 is a flow chart outlining the steps for shading the interior of the vehicle according to the teachings of the present invention.

### DESCRIPTION OF THE INVENTION

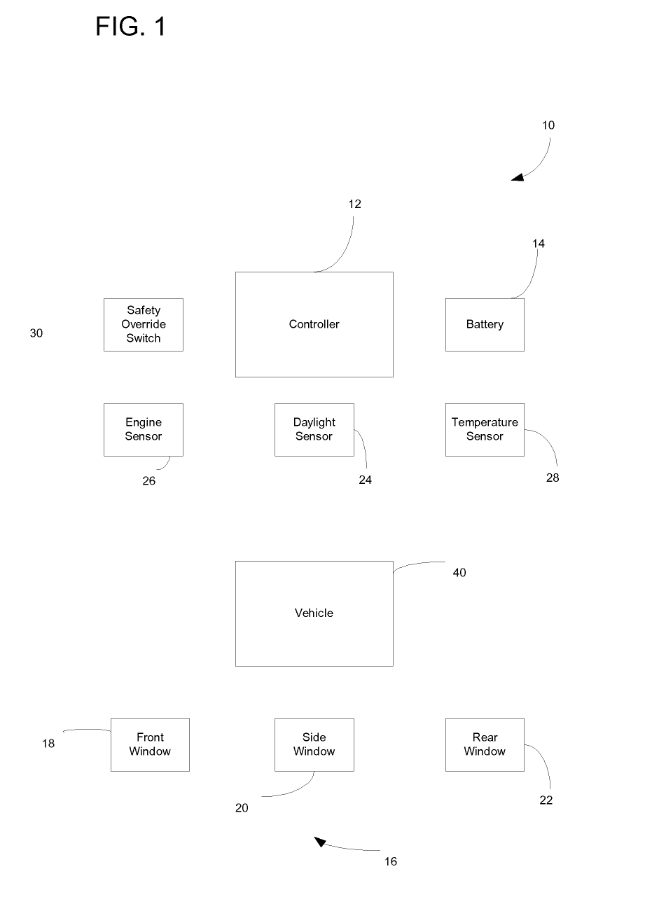

The present invention is a system and method for shading the windows of a vehicle. FIG. 1 is a simplified block diagram of a vehicle shading system 10 in the preferred embodiment of the present invention. The system includes a controller 12 powered by a power source, such as a vehicle battery 14. The system includes a plurality of window panels 16, such as the front window panel 18, side window panels 20, and a rear window panel 22. The vehicle shading system may also include a daylight sensor 24, an engine off sensor 26 and a temperature sensor 28. In addition, in the preferred embodiment of the present invention, the vehicle shading system includes a safety override switch 30.

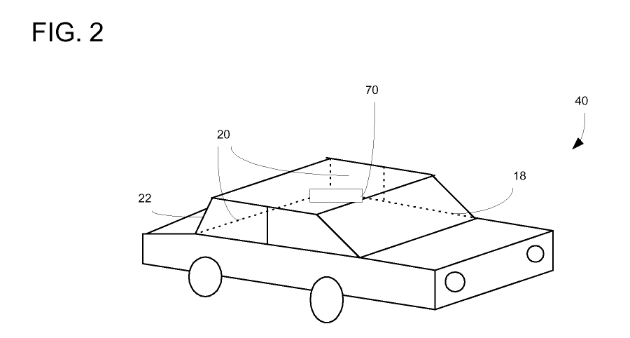

FIG. 2 is a simplified illustration of the plurality of window panels 16 of a vehicle 40 shaded by the vehicle shading system 10 of FIG. 1. The present invention replaces mechanical shades by utilizing an electrically controlled transmission control material. In one embodiment, one or more of the window panels are constructed of the transmission control material. In another embodiment, the window panel is applied with a transmission control material film or panel. FIG. 2 illustrates an exemplary vehicle. It should be understood that the number and position of the windows may vary by the type and model of the vehicle.

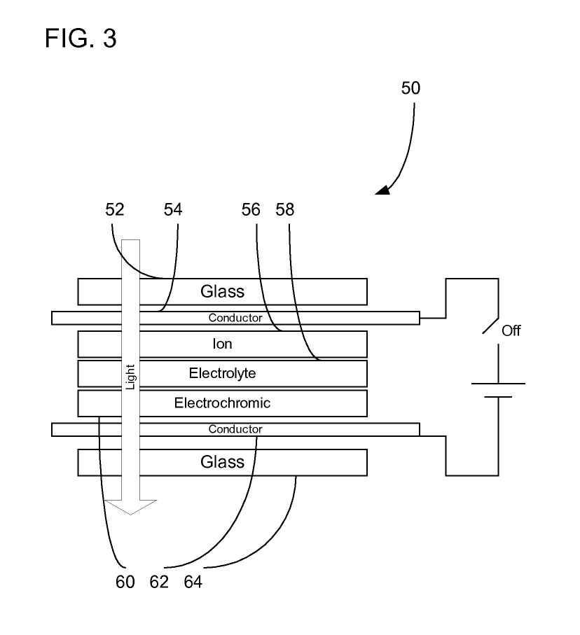

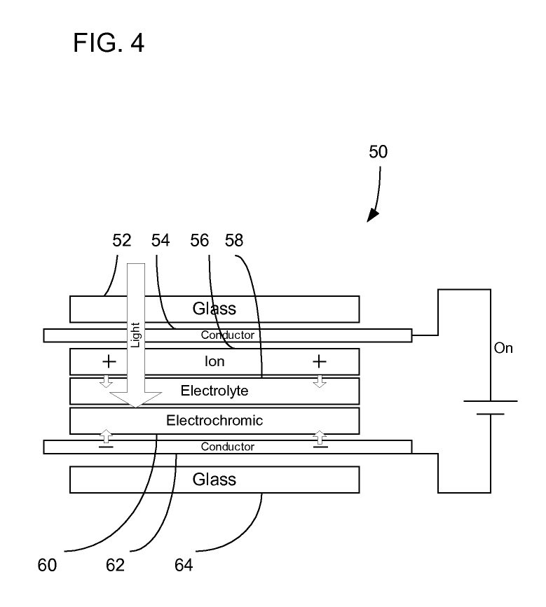

FIG. 3 is an illustration of a transmission control material panel 50 (electrochromic window panel), such as the window panel 18 utilized in the vehicle shading system 10 in an off position. FIG. 4 is an illustration of the transmission control material panel 50 in an on position. An electrochromic window utilizes a transmission control material whose transmissivity is changed by application of power. In a similar fashion as suspended particle devices, electrochromic windows may be adjusted to allow varying levels of visibility.

Electrochromic windows include specialized materials that have electrochromic properties. Electrochromic materials are those materials that can change color when energized by an electrical current. In its most basic form, electricity initiates a chemical reaction. This reaction changes the properties of the material. In this case, the reaction changes the way the material reflects and absorbs light. In some electrochromic materials, the change is between different colors. In electrochromic windows, the material changes between a colored state (reflecting light of same color) and a transparent state, which does not reflect any light.

Referring to FIGS. 3 and 4, the transmission control material panel 50, in one embodiment, includes an outer panel 52 constructed of glass or plastic, an oxide conductor 54, an ion storage layer 56, an ion conducting layer (electrolyte) 58, an electrochromic layer 60 (e.g., tungsten oxide), a second oxide conducting layer 62, and an inner panel 64. In this embodiment, the chemical reaction is an oxidation reaction wherein molecules in a compound lose electrons. Ions in the sandwiched electrochromic layer 60 are what allow it to change from opaque to transparent. The ions allow the electrochromic layer to absorb light. A power source (battery 14) is wired to the two oxide conductor layers 54 and 62. A voltage from the power source drives the ions from the ion storage layer 56 through the ion conducting layer 58 and into the electrochromic layer. This makes the glass opaque. By shutting off the voltage, the ions are driven out of the electrochromic layers and into the ion storage layer. When the ions leave the electrochromic layer, the window regains its transparency.

In an alternate embodiment of an electrochromic window, electricity is only required to make the initial change to opacity. Maintaining a particular shade does not require constant voltage. Only a sufficient voltage is needed to make the change and then enough voltage to reverse the change. In another embodiment of the electrochromic window, electricity is applied to change the glass to opaque and electricity is removed to change the glass to transparent. It should be understood that the electrochromic window may be configured in a wide variety of ways and materials which allow a window to change its opacity by applying current to the window and still remain in the scope of the present invention (e.g., LCD glass or other transmission control material).

The vehicle shading system 10 provides shade to the interior of the vehicle 40 when the vehicle is parked. The present invention replaces the existing mechanical shades with an automatically controlled transmission control material layer 50 embedded in the window panels 16. This transmission control material layer may be constructed of an electrochromic material, liquid crystal diode (LCD), or any other material whose transmission and reflectivity properties are changed by applying an electrical current. By controlling the transmissivity and reflectivity, the amount of heat and light entering the vehicle is controlled. When the vehicle is parked under sunny conditions, the transmission control material layer 50 is activated, thereby causing the transmission control material layer to become opaque. During normal driving conditions, the transmission control material is deactivated, thereby providing transparent window panels.

In the preferred embodiment of the present invention, all the window panels 16 are either made with transmission control material or applied with the transmission control material layer in a panel form or as a film. All of the window panels 16 are connected to the controller 12. The controller receives power from the battery 14. The controller is also optionally connected to the engine off sensor 26, the daylight sensor 24, and the temperature sensor 28. The safety override switch 30 may be provided between the power path to the window panels to disable the power to the transmission control material within the window panels.

The transmission control material layer, located within the window panels 16, is transparent when electricity is not applied to the system. The controller 12 receives its power from the battery 14 and controls the power to the window panels 16. The controller includes a processor providing intelligence to control when power is applied to the window panels. In the preferred embodiment of the present invention, the controller optionally determines if the vehicle's engine is off through the engine off sensor 26 or by checking the load on the battery. In addition, the controller optionally determines the sunlight state from the daylight sensor 24. The controller may also determine the inside vehicle temperature from the temperature sensor 28 located within the vehicle, which monitors the temperature within the vehicle. Additionally, the controller may check the power available in the battery.

When the controller determines that the vehicle's engine is off, and/or that there is sunlight present, and/or that there is sufficient power available in the battery 14, the controller allows power to be provided to the window panels 16. If the temperature sensor 28 is utilized, the controller may check the inside temperature of the vehicle to determine if it is sufficiently hot to warrant activating the shading system 10. The safety override switch 30 may be provided to disable power to the window panels 16 in cases of emergency to immediately change the windows to a clear state. If the controller detects that the vehicle's battery power is below a predetermined specified level, the controller removes the power from the window panels. Once power is applied to the window panels, the transmission control material within the window panels blocks most of the light, thereby shading the interior of the vehicle. By choosing the material of the transmission control material, the spectrum of light being transmitted (visible, infrared, and ultraviolet) is controlled. By controlling the visible and infrared portions, the heat entering the vehicle is limited. By controlling the ultraviolet portion of light, the fading of the vehicle's interior is reduced.

In an alternate embodiment of the present invention, the vehicle battery's power may be conserved by supplying alternatively pulsed power to the window panels 16. In this embodiment, the window panels are made with transmission control material that changes state at a slower pace from opaque to transparent (e.g., four seconds). A pulsed power with a frequency (e.g., two seconds) and a pulse width (e.g., 50 milliseconds) keep the panels in an opaque state while using lower power (e.g., 1/40^{th} the power necessary in the embodiment discussed above).

In another alternate embodiment of the present invention, the electrochromic material does not require constant power to maintain the opacity. In this alternate embodiment, power is only applied when the change of state (i.e., from transparent to opaque or opaque to transparent) is required.

In still another embodiment, the vehicle shading system 10 may receive power from a solar powered panel 70 (FIG. 2) located on top of the vehicle or transparent solar cells built into the window panels. The vehicle shading system may also combine the transmission control material with a transparent heater, such as indium-tin oxide film, embedded within the window panels. Power is simultaneously applied to the transparent heater film during cold weather to prevent fog buildup on the window panels. In an alternate embodiment of the present invention, the vehicle shading system may be manually turned on and off as desired by the user.

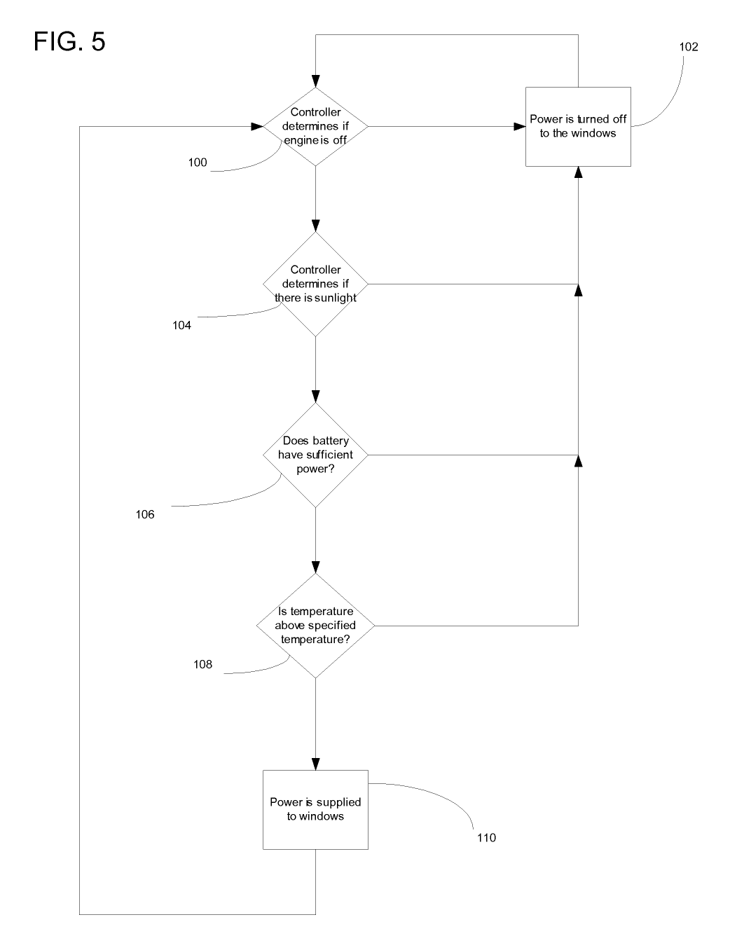

FIG. 5 is a flow chart outlining the steps for shading an interior of the vehicle 40 according to the teachings of the present invention. With reference to FIGS. 1-5, the steps of the method will now be explained. The method begins in step 100 where the controller 12 optionally determines if the engine of the vehicle 40 is off by monitoring the state of the engine through the engine off sensor 26 or by monitoring the load on the battery 14. If it is determined that the engine is on, the method moves to step 102 where power is turned off to the window panels 16. At step 102, after turning off the power, the method moves to step 100 where the process begins again. However, if it is determined that the engine is off, the method moves from step 100 to step 104 where it is optionally determined if there is sunlight. The controller may optionally determine if there is sunlight through the daylight sensor 24. If it is determined that there is not daylight, the method moves to step 102 where power is turned off.

However, if it is determined that there is sunlight, the method moves from step 104 to step 106 where it is optionally determined if the battery 14 has sufficient power. A predetermined specified power level may be set for determining the sufficiency of the power state of the battery. If it is determined that there is not sufficient power, the method moves from step 106 to step 102 where the power to the window panels 16 is turned off. However, in step 106, if it is determined that the battery has sufficient power, the method moves to step 108 where it is optionally determined by the temperature sensor 28 if the temperature is above a predetermined specified temperature (e.g., 60 degrees F.). If the temperature is below the predetermined specified temperature, the method moves to step 102 where the power is turned off to the window panels 16. However, if it is determined in step 108 that the temperature is above the predetermined specified temperature, the method moves to step 110 where power is supplied to the window panels. With power supplied to the window panels, the transmission control material is darkened, thereby providing shade to the interior of the vehicle 40. Next, the method moves back to step 100 where the process is repeated. Alternately, in step 110, power may be momentarily provided to the window panels to change the transmissivity of the windows where the transmission control material requires only a burst of electric current to change the transmissivity of the windows.

The present invention provides many advantages over existing vehicle shading systems. The present invention automatically determines when the shading system is utilized. Specifically, the present invention determines if selected preconditions are present (e.g., sunlight, high temperature, engine turned off), that the shading system is activated. The present invention provides shade to the interior of the vehicle without requiring the user to deploy any mechanical shades. The present invention also provides shade to all the windows.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A vehicle shading system for shading an interior of a vehicle, the vehicle shading system comprising:
a window located on the vehicle, the window having a transmission control material having means for changing a transmissivity of the window between a transparent state and an opaque state by an application of an electric current to the transmission control material;
a power source providing electric current to the transmission control material; and
whereby the window is changed from transparent to opaque upon the application of electric current to the transmission control material, thereby shading the interior of the vehicle.

2. The vehicle shading system for shading an interior of a vehicle of claim 1 further comprising a controller for controlling application of an electric current to the transmission control material.

3. The vehicle shading system for shading an interior of a vehicle of claim 2 wherein the controller activates the shading system upon sensing from an engine sensor that an engine of the vehicle is turned off.

4. The vehicle shading system for shading an interior of a vehicle of claim 2 wherein the controller activates the shading system upon sensing daylight from a daylight sensor attached to the vehicle.

5. The vehicle shading system for shading an interior of a vehicle of claim 2 wherein the controller activates the shading system upon sensing that an interior temperature of the vehicle sensed by a temperature sensor within the interior of the vehicle is above a predetermined temperature.

6. The vehicle shading system for shading an interior of a vehicle of claim 2 wherein the controller activates the shading system upon sensing that an engine of the vehicle is turned off and sensing from that an interior temperature of the vehicle sensed by a temperature sensor within the interior of the vehicle is above a predetermined temperature.

7. The vehicle shading system for shading an interior of a vehicle of claim 2 further comprising a safety override switch to bypass the controller and commanding the plurality of windows to remain transparent by removing the electric current from the transmission control material of each window.

8. The vehicle shading system for shading an interior of a vehicle of claim 1 wherein the transmission control material is opaque when an electric current is applied to the transmission control material and transparent when the electric current is removed from the transmission control material.

9. The vehicle shading system for shading an interior of a vehicle of claim 1 wherein the transmission control material transitions slowly from opaque to clear upon removal of the electric current and the controller provides a pulsed electric current to the transmission control material to activate the shading system.

10. The vehicle shading system for shading an interior of a vehicle of claim 1 further comprising a plurality of windows and wherein the plurality of windows are darkened by the application of electrical current to the transmission control material of each window.

11. The vehicle shading system for shading an interior of a vehicle of claim 2 wherein the power source is a battery of the vehicle.

12. The vehicle shading system for shading an interior of a vehicle of claim 11 further comprising a sensor to detect a power level of the battery and wherein the controller does not command electric current to the transmission control material when the power level of the battery is below a predetermined level.

13. The vehicle shading system for shading an interior of a vehicle of claim 1 wherein the power source is a solar cell affixed to a top portion of the vehicle.

14. The vehicle shading system for shading an interior of a vehicle of claim 1 wherein the power source is a transparent solar power source.

15. The vehicle shading system for shading an interior of a vehicle of claim 1 wherein the window includes a transparent heater layer for heating the window for defogging.

16. The vehicle shading system for shading an interior of a vehicle of claim 1 wherein the transmission control material remains a constant state of opaque or state of transparent without electric current being applied and changes from opaque to transparent or changes from transparent to opaque upon the application of the electric current.

17. The vehicle shading system for shading an interior of a vehicle of claim 1 wherein the power source is manually actuated by a user to provide electric current to the transmission control material and activate the shading system.

18. A method of shading an interior of a vehicle, the method comprising the steps of:
applying an electric current to a window of a vehicle, wherein the window includes a transmission control material layer which changes the transmissivity of the window between a transparent state and an opaque state by an application of electric current to the transmission control material; and
upon application of the electric current to the window, transforming the window from transparent to opaque to shade the interior of the vehicle.

19. The method of shading an interior of a vehicle of claim 18 further comprising the step of determining an appropriate time by a controller to apply the electric current to the window of the vehicle.

20. The method of shading an interior of a vehicle of claim 19 wherein the step of determining an appropriate time by a controller to apply an electric current includes sensing a temperature of the interior of the vehicle, whereby the appropriate time to apply the electric current is determined when the interior temperature is above a specified temperature.

21. The method of shading an interior of a vehicle of claim 19 wherein the step of determining an appropriate time by a controller to apply an electric current includes sensing if there is daylight, whereby the appropriate time to apply the electric current is determined when daylight is detected.

22. The method of shading an interior of a vehicle of claim 19 wherein the step of determining an appropriate time by a controller to apply an electric current includes sensing if an engine of the vehicle is off, whereby the appropriate time to apply the electric current is determined when the engine is sensed to be turned off.

23. The method of shading an interior of a vehicle of claim 19 wherein:
the electric current is applied by a vehicle battery; and
the step of determining an appropriate time by a controller to apply an electric current includes sensing a power level of the battery, whereby the appropriate time to apply the electric current is determined when the battery level is above a specified level.

24. The method of shading an interior of a vehicle of claim 19 wherein the transmission control material transitions slowly from opaque to clear upon removal of the electric current and the controller provides a pulsed electric current to the transmission control material to activate the shading system.

25. The method of shading an interior of a vehicle of claim 18 wherein the electric current is applied by a solar power source.

26. The method of shading an interior of a vehicle of claim 18 further comprising a plurality of windows having a transparent heater layer for heating the windows to defog the windows and further comprises the step of applying electric current to the transparent heater layer to defog the plurality of windows.
